(19) United States
(12) Patent Application Publication
(10) Pub. No.: US 2026/0278950 A1
(43) Pub. Date: Sep. 17, 2026

(54) ELECTRONIC IMAGE STABILIZATION FOR EXTENDED REALITY APPLICATION

(71) Applicant: Google LLC, Mountain View, CA (US)

(72) Inventors: Kinjal Ajitkumar Bhavsar, Fremont, CA (US); Chucai Yi, Fremont, CA (US); Fuhao Shi, San Jose, CA (US); Abhishek Kar, Fremont, CA (US); Greg Michael Underwood, Mountain View, CA (US); Eliza Velasquez, San Francisco, CA (US); Peter Haydn Naylor, Sunnyvale, CA (US); Stevan Lacerda Muniz Silva, San Jose, CA (US); Michael Jared Finder, Milpitas, CA (US); Chia-Kai Liang, Cupertino, CA (US)

(21) Appl. No.: 19/167,226

(22) PCT Filed: May 9, 2024
(86) PCT No.: PCT/US2024/028680

§ 371 Date: Sep. 19, 2025

Related U.S. Application Data
(60) Provisional application No. 63/501,103, filed on May 9, 2023.

(51) Int. Cl. G06T 19/00; G06T 3/18

(52) U.S. Cl. CPC G06T 19/006; G06T 3/18

(57) ABSTRACT

A method including generating a mesh using inertial data, the mesh representing movement associated with a device in at least a portion of a real-world environment, generating stabilized image data based on image data and the mesh, and generating stabilized virtual data based on the stabilized image data.

### CROSS REFERENCE TO RELATED APPLICATION

This application claims the benefit of U.S. Provisional Application No. 63/501,103, filed May 9, 2023, the disclosure of which is incorporated herein by reference in its entirety.

### BACKGROUND

At least one objective of extended reality (XR), including mixed reality (MR), augmented reality (AR) and virtual reality (VR), is to enhance the user's perception of the physical or virtual world, blended with a new and engaging digital environment. These technologies are usually integrated into specific consumer-grade mobile devices (smartphones, glasses and other wearables), and their attractive user experiences are based on real-time video capture and playback.

### SUMMARY

Implementations relate to combining electronic image stabilization (EIS) with motion tracking in software to improve video stabilization for computing devices (e.g., AR/XR/VR devices) configured to interact with XR experience. To improve video stabilization for streaming videos in XR experiences, EIS and motion tracking are performed in software with synchronized image data and inertial data. The resultant EIS warping mesh data (e.g., a mapping between motion data and image data) can be used to generate a stabilized image.

In a general aspect, a device, a system, a non-transitory computer-readable medium (having stored thereon computer executable program code which can be executed on a computer system), and/or a method can perform a process with a method including generating a mesh using inertial data, the mesh representing movement associated with a device in at least a portion of a real-world environment, generating stabilized image data based on image data and the mesh, and generating stabilized virtual data based on the stabilized image data.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a system for generating a stabilized image according to an example implementation.

FIG. 2 illustrates a block diagram of a signal flow for generating a stabilized image according to an example implementation.

FIG. 3A pictorially illustrates a user operating the system for generating a stabilized image according to an example implementation.

FIG. 3B illustrates a block diagram of a signal flow for determining a coordinate in a stabilized image according to an example implementation.

FIG. 4 illustrates a block diagram of a signal flow for a portion of a computing system according to an example implementation.

FIG. 5 illustrates outputs of an EIS system according to an example implementation.

FIG. 6 illustrates camera elements of an EIS system according to an example implementation.

FIG. 7 illustrates camera texture crops to match the view aspect ratio according to an example implementation.

FIG. 8 pictorially illustrates an inverse homography transform according to an example implementation.

FIG. 9 illustrates a block diagram of a method for generating a stabilized image according to an example implementation.

FIG. 10 illustrates a block diagram of a method for determining a coordinate in a stabilized image according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

A computing device can be configured to capture an image of the real-world. In addition, the computing device can be configured to combine virtual content with the image of the real-world. For example, the image of the real-world can be a background image on which the virtual content is overlaid when rendering for display on the computing device. To provide a preferred user experience, the image of the real-world can be stabilized. In other words, shaking, bouncing, vibration, and/or the like can be reduced (e.g., minimized) in the image of the real-world. In addition, the image of the real-world and the virtual content can be temporally synchronized. In other words, the virtual content is combined with the stabilized image of the real-world at the appropriate time.

A front facing camera of a computing device can be configured to capture the image of the real-world for rendering on a display of the computing device. At the same time, the user can be moving within the real world and/or not holding the front facing camera steady. In previous methods, electronic image stabilization (EIS) and/or optical image stabilization (OIS) would be performed at the camera hardware. Performing EIS and/or OIS in the camera hardware is undesirable in computing devices because merging virtual content with optically stabilized image data doesn't work well because the virtual content may not be placed in the desired location of the image of the real-world. Accordingly, at least one technical problem with performing image stabilization by the front facing camera hardware, data related to the user movement cannot be an element of the stabilized image. Further, if the data related to the user movement were an element of the stabilized image (which it is not), the user movement would not be accounted for in the virtual content.

At least one technical solution to the technical problem can be that the image is not stabilized by the camera hardware. In addition, inertial data (e.g., inertial measurement unit (IMU) data) is used to stabilize the image in software. Therefore, user movement is an element of stabilization. Further, the inertial data is also applied to the virtual content such that the image and virtual content are both stabilized using the same data. At least one technical effect of the technical solution is that the virtual content is in the correct position on the image when rendered on a display of the computing device.

At least one technical solution to the technical problem can be to stabilize the image in software. For example, a mesh representing movement associated with the device can be used to transform an unstable image into a stable image. Further, the mesh representing movement associated with the device can be used to transform virtual content to align the virtual content with the stable image. At least one technical effect of the technical solution is that the virtual content is in the correct position on the image when rendered on a display of the computing device.

Stabilizing the image using an application can also be accomplished by mapping image data using an invertible matrix. For example, an invertible matrix representing movement associated with the device can be used to map data representing an unstable image into data representing a stable image. Further, the invertible matrix can be used to map virtual content to align the virtual content with the stable image. At least one technical effect of the technical solution is that the virtual content is in the correct position on the image when rendered on a display of the computing device.

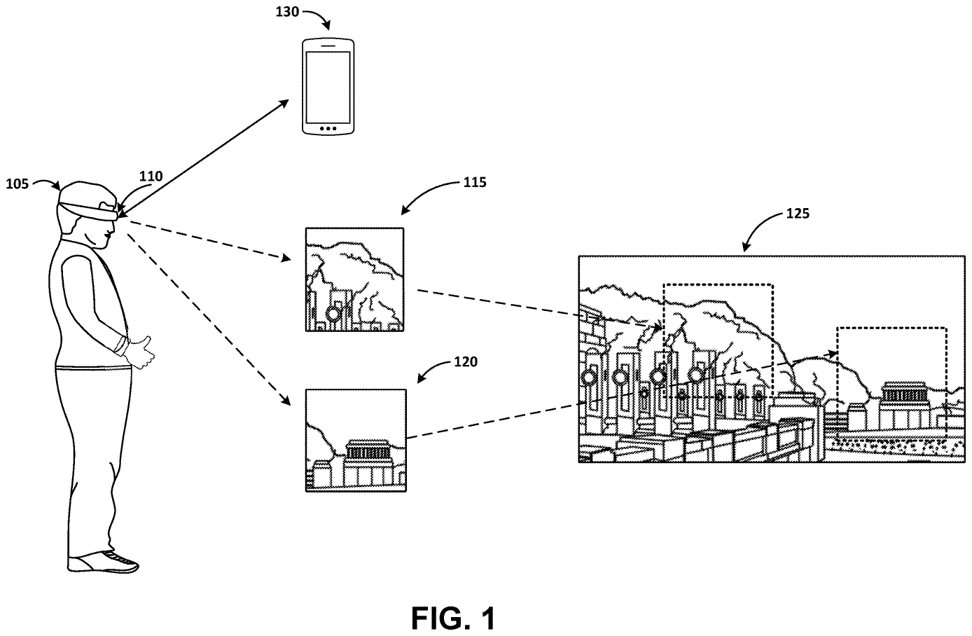

FIG. 1 illustrates a system for generating a stabilized image according to an example implementation. As shown in FIG. 1, the system includes a user 105, a wearable device 110, and a companion device 130. Also shown in FIG. 1 is a first portion 115 of a real-world environment 125, a second portion 120 of the real-world environment 125. The wearable device 110 can be configured to generate image data representing the first portion 115 of the real-world environment 125 and image data representing the second portion 120 of the real-world environment 125. The wearable device 110 can be configured to generate inertial data (not shown) representing movement of the wearable device 110 and/or the user 105 from viewing the first portion 115 of the real-world environment 125 and viewing the second portion 120 of the real-world environment 125.

The wearable device 110 can be, for example, a smart glasses device (e.g., AR glasses device), a head mounted display (HMD), a computing device, a wearable computing device, and the like. User 105 can be viewing a real-world view in any direction. The wearable device 110 can be configured to generate an image burst (e.g., approximately ten, sometimes underexposed, frames) of the real-world. The image data representing the first portion 115 of the real-world environment 125 and image data representing the second portion 120 of the real-world environment 125 can be generated based on the image burst. As mentioned above, performing image stabilization by the camera hardware can be problematic. Therefore, in some implementations, image data associated with the image burst is not stabilized by the camera hardware. Accordingly, the image stabilization can be performed by a processor of the wearable device 110 and/or a processor of the companion device 130.

In some implementations, the wearable device 110 can be configured to perform the processing described herein. However, the companion device 130 (e.g., a computing device, a mobile phone, a tablet, a laptop computer, and/or the like) can be configured to receive (e.g., via a wired and/or wireless connection) the image data representing the first portion 115 of the real-world environment 125, image data representing the second portion 120 of the real-world environment 125, and the inertial data. The image data representing the first portion 115 of the real-world environment 125, image data representing the second portion 120 of the real-world environment 125, and the inertial data can be further processed by the companion device 130. For example, image data can be stabilized based on inertial data. For example, virtual content or virtual data can be stabilized based on inertial data. For example, a VR image can be generated for display on the wearable device 110 based on the stabilized image data and the stabilized virtual data.

Image stabilization can counteract vibrations of the camera while image data is captured. Accordingly, stabilized image data is image data with vibration (e.g., noise data) removed. The vibration can be in both horizontal and vertical directions. Image stabilization can be configured to balance the yaw (rotation on the Y-axis) and the pitch (rotation on the X-axis). In some implementations, each data point in unstable image data can be offset (e.g., in the x and/or y direction) to generate stabilized image data. In some implementations, stabilized virtual data can be virtual data that aligned with the stabilized image data. Therefore, each data point in initial or original virtual data can be offset (e.g., in the x and/or y direction) to generate stabilized virtual data.

In some implementations, virtual data can be the computer data representing the virtual content. For example, virtual data can be in the format of a mesh. For example, virtual data can be in the format of a 3D mesh. In other words, the virtual data can be a set of vertices, edges and faces that define the virtual content. In some implementations, the virtual content can be or can include geometric structures that can be modelled using, for example, a computer-aided drawing (CAD) tool. Therefore, for example, virtual data can be in the format of a model or three-dimensional (3D) model generated using the CAD tool. The model can be stored (e.g., in a memory) in a mesh (or mesh like) format.

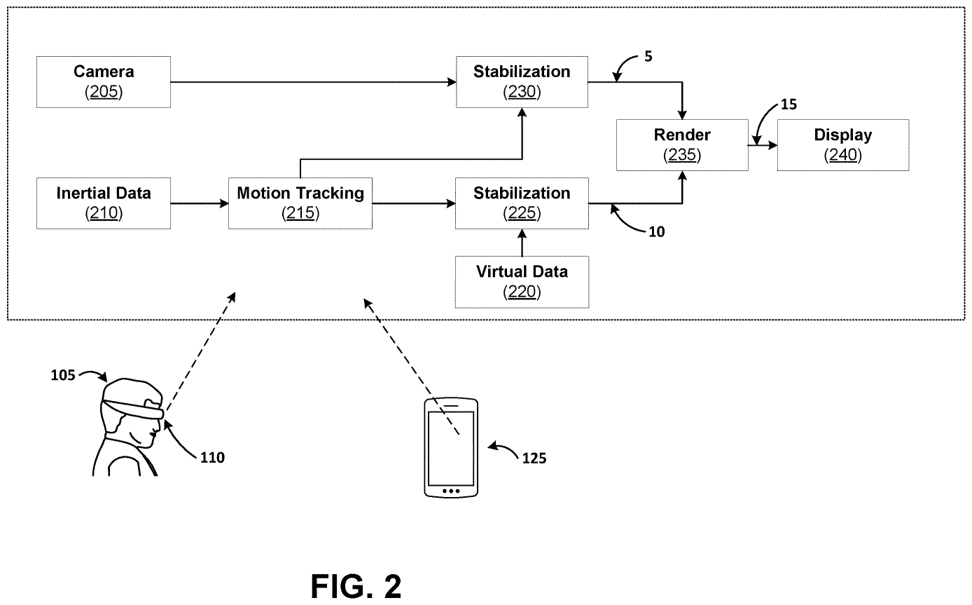

FIG. 2 illustrates a block diagram of a signal flow for generating a stabilized image according to an example implementation. As shown in FIG. 2, the signal flow includes a camera 205 block, an inertial data 210 block, a motion tracking 215 block, a virtual data 220 block, a stabilization 225 block, a stabilization 230 block, a render 235 block, and a display 240 block. As shown in FIG. 2, wearable device 110 can perform the signal flow. As shown in FIG. 2, companion device 130 can perform the signal flow. As shown in FIG. 2, wearable device 110 and companion device 130 together can perform the signal flow.

As shown in FIG. 2, the render 235 block can receive stabilized image data 5 and stabilized virtual data 10 and generate a stabilized image 15. In some implementations generating stabilized image 15 can include rendering the stabilized image data 5 and the stabilized virtual data 10. In some implementations, rendering the stabilized image data 5 and the stabilized virtual data 10 can include overlaying an image based on the stabilized virtual data 10 onto an image based on the stabilized image data 5. The stabilized image 15 can be displayed on display 240. In some implementations, the stabilized image 15 can correspond to a frame of a video. In some implementations, display 240 can be associated with a computing device (e.g., wearable device 110). In some implementations, display 240 can be a non-passthrough display. A non-passthrough display can be a display where a user (e.g., of the computing device) cannot view the real world through the display. In other words, a non-passthrough display can be a display where a user (e.g., of the computing device) only views the image (or frame) that is displayed on the display (e.g., the display 240 and/or a housing or other layer covering the display can be opaque).

As shown in FIG. 2, camera 205 can be configured to capture (e.g., sense, generate, and the like) image data (e.g., the first portion 115 of the real-world environment 125, image data representing the second portion 120 of the real-world environment 125). Camera 205 can be associated with (e.g., an element of) the computing device (e.g., wearable device 110). The camera 205 can be a forward-looking camera of the computing device. Therefore, camera 205 can be configured to capture image data associated with, for example, a real-world environment and/or at least a portion of a real-world environment. The real-world environment can be associated with the direction and/or a pose of the computing device.

Inertial data can be data associated with the movement of a computing device. For example, inertial data can be used in a pose tracking system associated with a computing device (e.g., wearable device 110). Pose tracking can include position and orientation (pitch, yaw and roll) tracking. Therefore, inertial data can include data associated with 6DoF tracking of the computing device. Inertial data can be associated with simultaneous localization and mapping (SLAM) and/or visual-inertial odometry (VIO).

As shown in FIG. 2, inertial data 210 can include, for example, data captured by an inertial measurement unit (IMU) of the computing device. In some implementations, inertial data 210 can further include calibration data (e.g., of motion devices), range sensor data, camera rolling shutter information, camera zooming information, and/or other sensor data. In some implementations, inertial data 210 can be generated and/or captured by a companion device. The motion tracking 215 block can be configured to generate motion tracking data based on inertial data 210. The motion tracking data can correspond to movement associated with the real-world environment or at least a portion of the real-world environment. The movement can represent movement of the computing device with respect to the real-world environment or at least a portion of the real-world environment.

A mesh (e.g., in graphics) can be a set of vertices and polygons representing, for example, a 3D object. In other words, mesh is a set of vertices, edges and faces that define the shape of a polyhedral object. A polygon mesh can represent the surface of the object and a volumetric mesh can represent the of the object and the volume of the structure of the object. In some implementations, a mesh can be used for rendering to a computer display. In some implementations, image data can be in mesh format and/or used to generate a mesh. In some implementations, a first mesh can be used to modify a second mesh. For example, the two meshes can have the same data structure and each data point of the first mesh can be used to modify (e.g., addition, subtraction, multiplication, division, and the like) a corresponding data point of the second mesh.

Warping an image can be manipulating an image so that elements in the image are distorted. Warping a mesh can be manipulating a mesh so that elements in the mesh are distorted when rendered. Warping an input image and/or a mesh can include mapping an input image and/or a mesh to an output image and/or mesh. The map can be a mesh or warp mesh used to modify the mesh. In some implementations, warping an image and/or a mesh can be performed in software. For example, the image and/or mesh and a map (algorithm, warping mesh) are input to the software and a warped image or mesh is output from the software.

Rendering the image can include rendering the mesh. Rendering the mesh can include rendering the geometry of the mesh a position defined by a component of the mesh data and at least one property of the computer display. In other words, the vertices, edges and faces that define the shape of the polyhedral object are mapped to pixels of the computer display.

As shown in FIG. 2, stabilization 225 and stabilization 230 blocks can be configured to generate a mesh based on the motion tracking data. Therefore, the mesh can be generated using the (or based on the) inertial data 210. In some implementations, the mesh can represent movement associated with the real-world environment or at least a portion of a real-world environment. In some implementations, the mesh can represent movement of the computing device with respect to the real-world environment or at least a portion of the real-world environment. In some implementations, the stabilization 230 block can be configured to generate the stabilized image data 5 based on the image data captured by the camera 205. In some implementations, the stabilization 230 block can be configured to generate the stabilized image data 5 based on the mesh representing movement associated with the real-world environment or at least a portion of a real-world environment. In some implementations, the stabilization 230 block can be configured to generate the stabilized image data 5 based on the mesh representing movement of the computing device with respect to the real-world environment or at least a portion of the real-world environment. In some implementations, the stabilization 230 block can be configured to generate the stabilized image data 5 based on the image data captured by the camera 205 and the mesh representing movement associated with the real-world environment or at least a portion of a real-world environment. In some implementations, the stabilization 230 block can be configured to generate the stabilized image data 5 based on the image data captured by the camera 205 and the mesh representing movement of the computing device with respect to the real-world environment or at least a portion of the real-world environment.

In some implementations, the stabilization 225 block can be configured to generate the stabilized virtual data 10 based on the virtual data 220. In some implementations, the stabilization 225 block can be configured to generate the stabilized virtual data 10 based on the mesh representing movement associated with the real-world environment or at least a portion of a real-world environment. In some implementations, the stabilization 225 block can be configured to generate the stabilized virtual data 10 based on the mesh representing movement of the computing device with respect to the real-world environment or at least a portion of the real-world environment. In some implementations, the stabilization 225 block can be configured to generate the stabilized virtual data 10 based on the virtual data 220 and the mesh representing movement associated with the real-world environment or at least a portion of a real-world environment. In some implementations, the stabilization 225 block can be configured to generate the stabilized virtual data 10 based on the virtual data 220 and the mesh representing movement of the computing device with respect to the real-world environment or at least a portion of the real-world environment.

In some implementations, the user can interact with an object associated with virtual data 220. However, the location of, for example, a hand of the user is offset based on the image stabilization. Further, the location of the object is offset based on the image stabilization. Therefore, a position, location, coordinate of, for example, the hand or object in the stabilized image (e.g., stabilized image 15) can be incorrectly determined using the stabilized image.

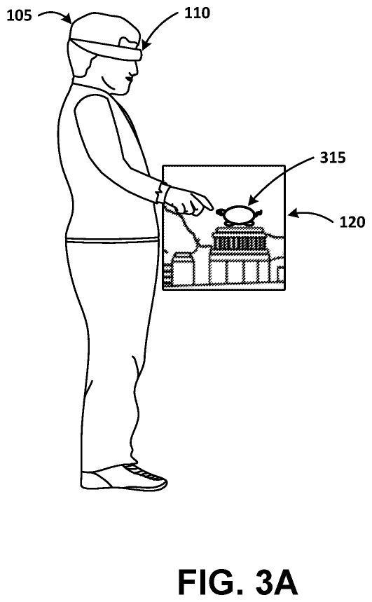

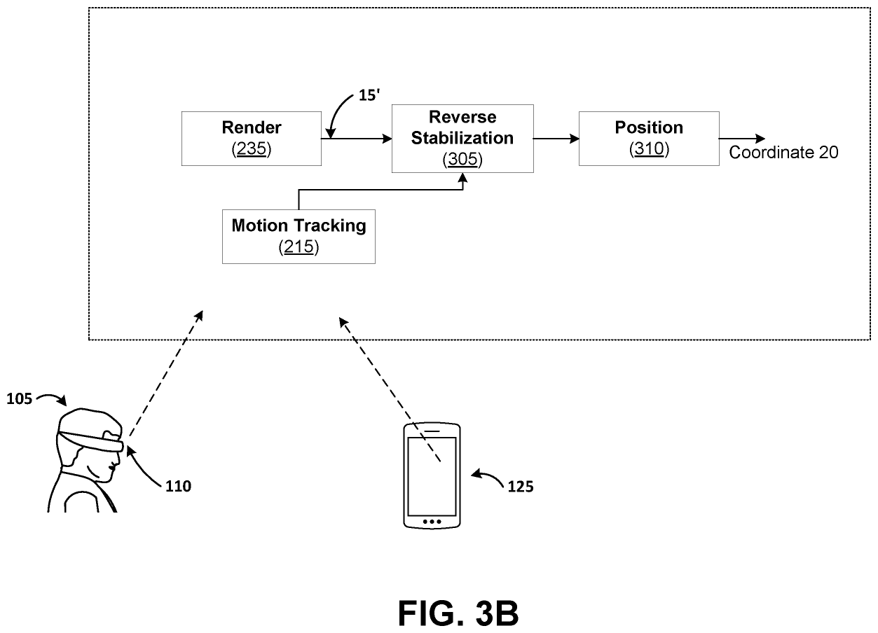

FIG. 3A pictorially illustrates a user operating the system for generating a stabilized image according to an example implementation. FIG. 3B illustrates a block diagram of a signal flow for determining a coordinate in a stabilized image according to an example implementation. As shown in FIG. 3B, the render 235 block generates a stabilized image 15′. Stabilized image 15′ can represent any later in time stabilized image as compared to stabilized image 15. The user (e.g., user 105) can, for example, reach into the real-world environment to, for example, interact with an object 315 as shown in FIG. 3A. In some implementations, object 315 can be associated with virtual data 220. The computing device and/or a companion device can be configured to determine that the user has reached into the real-world environment, based on, for example, image data associated with the real-world environment. For example, in some implementations, the computing device and/or a companion device can be configured to identify a portion of the user in the image data. For example, in some implementations, the portion of the user can be identified in the stabilized image 15′.

In response to identifying a portion of the user in the image and/or image data, determining a coordinate in the image and/or image data can be triggered. For example, in response to identify a portion of the user in stabilized image 15′, determining a coordinate of the portion of the user in stabilized image 15′ can be triggered. In some implementations, stabilized image 15′ can be un-stabilized. For example, reverse stabilization 305 block can be configured to generate un-stabilized image data based on stabilized image 15′. The reverse stabilization 305 block can be configured to generate a mesh based on the motion tracking 215 data. Therefore, the mesh can be generated using the (or based on the) inertial data 210. In some implementations, the mesh can represent movement associated with the real-world environment or at least a portion of a real-world environment. In some implementations, the mesh can represent movement of the computing device with respect to the real-world environment or at least a portion of the real-world environment. In some implementations, the mesh (e.g., second mesh) generated by the reverse stabilization 305 block can be the inverse of the mesh (e.g., first mesh) generated by stabilization 225 and stabilization 230 blocks and the algorithm used to generate the un-stabilized image data can be the same as the algorithm used to generate the stabilized image data. In some implementations, the mesh generated by the reverse stabilization 305 block can be the same as the mesh generated by stabilization 225 and stabilization 230 blocks and the algorithm used to generate the un-stabilized image data can be the inverse of the algorithm used to generate the stabilized image data.

The position 310 block can be configured to generate at least one coordinate 20 based on the un-stabilized image data. The un-stabilized image data can include the portion of the user and objects associated with the virtual data 220. Therefore, in some implementations, position 310 block can be configured to generate at least one coordinate 20 associated with the portion of the user. In some implementations, position 310 block can be configured to generate at least one coordinate 20 associated with an object(s) associated with the virtual data 220. In some implementations, position 310 block can be configured to generate at least one coordinate 20 associated with the portion of the user and an object(s) associated with the virtual data 220. As shown in FIG. 3B, wearable device 110 can perform the signal flow. As shown in FIG. 3B, companion device 130 can perform the signal flow. As shown in FIG. 3B, wearable device 110 and companion device 130 together can perform the signal flow.

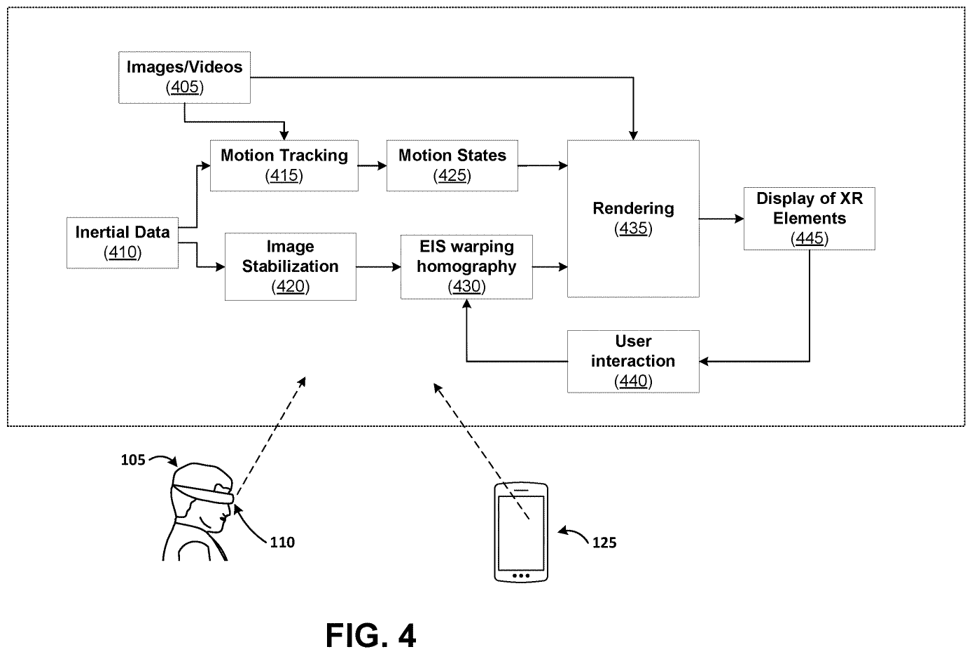

In some implementations, a computing system with device motion tracking can be operating on, for example, consumer-grade mobile devices with multiple sensors. In some implementations, the computing system can use complex categories of sensor data as input and then produce a variety of geometric elements for XR renderings and experiences. In some implementations, the computing system can include a signal flow to coordinate the sensor data and fuse the EIS processes with the computer displays for a coherent XR experience in real-time. FIG. 4 illustrates a block diagram of a signal flow for a portion of a computing system according to an example implementation. As shown in FIG. 4, the signal flow includes an images/videos 405 block, an inertial data 410 block, a motion tracking 415 block, an image stabilization 420 block, a motion states 425 block, an EIS warping homography 430 block, a rendering 435 block, a user interaction 440 block, and a display of XR elements 445 block. As shown in FIG. 4, wearable device 110 can perform the signal flow. As shown in FIG. 4, companion device 130 can perform the signal flow. As shown in FIG. 4, wearable device 110 and companion device 130 together can perform the signal flow.

In some implementations, a homography can be an invertible mapping (e.g., an invertible matrix or mesh) of points and lines on a projective plane. Other terms can include collineation, projectivity, and planar projective transformation. A projective plane is a system of points and lines that satisfy (1) any two distinct points are joined by exactly one line, (2) any two distinct lines meet in exactly one point, and (3) there exists a quadrangle or four points of which no three are collinear.

A homography is sometimes defined as an invertible mapping from a projective plane to itself such that three points lie on the same line if and only if their mapped points are also collinear. A mapping from a projective plane to itself can be a projectivity (or plane-to-plane projectivity) if there exists a non-singular matrix (or mesh) H. Matrix (or mesh) H can be changed by multiplying by an arbitrary non-zero constant without altering the projective transformation. Therefore, H is considered a homogeneous matrix. Homographies can be estimated between images by finding feature correspondences in those images. The projective transformation is a non-singular linear transformation of homogeneous coordinates. Therefore, a mesh can be used to represent homography data that transforms a first image to a second image. The transformation can be a non-singular linear transformation. In some implementations, a mesh can be used to represent homography data that transforms an unstable image to a stable image.

In some implementations, the inputs of the computing system can include camera-based RGB images and the extracted visual features as visual data. In some implementations, the inputs of the computing system can include IMU measurements including, for example, gyroscope and accelerometer as inertial data. In some implementations, the inputs of the computing system can include other types of sensors as supported by the computing device, such as ranging sensors (time-of-flight TOF) and motion sensors. In some implementations, the sensors can be pre-calibrated to geometrically model the sensor data, including the camera intrinsics, the IMU intrinsics and biases, the sensor clock offsets, the relative pose of different sensors, and/or the like.

In some implementations, the outputs of the computing system can include camera images and/or videos. For example, the computing system can be configured to capture images using the computing device's camera and analyze the images to identify and process the real-world environment. In some implementations, the outputs of the computing system can include a three-dimensional (3D) point cloud. For example, the computing system can be configured to use images to create a 3D point cloud of the real-world environment. Accordingly, the computing system can be configured to determine depth and position data of objects in the scene. In some implementations, the outputs of the computing system can include feature points. For example, the computing system can be configured to identify distinctive features in the camera images, such as corners or edges of objects. These features can be used to track the device's movement.

In some implementations, the outputs of the computing system can include an odometry pose. For example, the computing system can be configured to use feature points to calculate the computing device's position and orientation in the real-world. This is known as odometry pose, which the computing system can be configured to use to provide a stable augmented reality experience as the user moves around in the real-world environment. The pose can be six (6) degrees-of-freedom (6DOF) including three-axes rotation and three-axes translation, and/or three-degrees-of-freedom (3DOF) with only the three-axes rotation.

In some implementations, the signal flow of FIG. 4 can be a unified workflow configured to coordinate and synchronize the data to bring-up the XR functionalities on a mobile device. For example, the input sensors associated with the images/videos 405 block (e.g., image data) and the inertial data 410 block (e.g., inertial data) can be temporally synchronized, so that the readings and measurements from multiple sensors can be coupled to support frame-based sensor fusion and data filtering, for both device motion tracking and EIS.

Temporally synchronizing (sometimes referred to as synchronizing) can align a time at which two or more data capture and/or data presentation events occur. For example, sound and audio are often synchronized in movies. Often in computing systems a clock signal is used to trigger an event. However, all events may not trigger on the same clock, or a first event may take longer than a second event to complete after receiving a trigger to start the event. For example, capturing image data may take less time to complete than capturing inertial data. Synchronization can be accomplished in hardware and/or software. For example, a hardware delay substantially equal to the time difference between capturing image data and capturing inertial data can be added to capturing image data. For example, inertial data can be modified in software (e.g., an amount of movement can be deleted) based on the time difference between capturing image data and capturing inertial data.

In some implementations, the EIS warping homography 430 and the streaming video frames associated with the images/videos 405 block can be synchronized so that the stabilization effect is applied to the expected target. In some implementations, the EIS warping homography 430 and the motion states 425 can be synchronized so that the stabilized videos/images can show the expected virtual content. In some implementations, the XR image/video of the image stabilization 420 block and the virtual content associated with the user interaction 440 block and the display of XR elements 445 block rendered from different sources can be warped by EIS (the EIS warping homography 430 block) to keep the visual consistency.

In some implementations, the computing system can include the features of object detection/recognition/tracking, 3D spatial mapping, and gesture recognition to enhance user experience. Therefore, user interactions with the displayed images/videos that have been warped by EIS may go through specific compensations to meet the original XR functionalities. The EIS process can be configured to utilize the inertial sensor data, thus the computing system can have lower computational cost than most computing systems that need to process the image/video-based visual data. Therefore, the integration of an example EIS system should not affect the real-time performance of the original computing system because the involved inputs/outputs are properly coordinated in a unified framework.

In some implementations, the EIS warping homography 430 block (sometimes called an EIS module) may not output stabilized images and/or videos. Instead, the EIS warping homography 430 block generates data used by the rendering 435 block. The data generated by the EIS warping homography 430 block can be used by the rendering 435 block to transform and/or warp image and/or video (e.g., video frames). In some implementations, warping image and/or video can be configured to provide temporal stabilization effects in the image and/or video. In some implementations, the EIS warping homography 430 block generates data for rendering with warping homography matrices. The warping homography matrices can be computed based on sensor measurements and calibrations (e.g., of the inertial data 410 block).

In some implementations, sensor measurements and calibrations can include gyroscope sensor data that provides the measurements of angular velocities in supported frequencies. In some implementations, sensor measurements and calibrations can include optical image stabilizer (OIS) that provides measurements of OIS shifts in supported frequencies. In some implementations, OIS measurements may not be used if the computing device locks its OIS. In some implementations, sensor measurements and calibrations can include a camera lens controller that provides the cropping and scaling parameters of the camera sensors to fit multiple zoom in, zoom out factors. In some implementations, sensor measurements and calibrations can include pre-calibrations of the involved sensors and cameras. The pre-calibrations can include, for example, camera calibration parameters (e.g., focal length, principal points, rolling shutters, and/or the like), IMU calibration parameters (e.g., gyro/accel biases, gyro/accel noise sigmas, scales and misalignments, and/or the like), OIS calibration parameters e.g., relations of camera lens shifts with camera intrinsic deltas, and/or the like), light sensor array calibration parameters (e.g., array sizes, image crops), and/or the like), and/or relative rigid pose among different sensors.

The EIS warping homography 430 block can be implemented as a software interface (e.g., a plug-in) in a computing system that uses real-time stabilized images/videos. An example pseudo code can be as follows:

```
struct EisFrameMetaData {
  // Frame identification metadata.
  int frame_id;
  uint32_t camera_id;
  int64_t central_exposure_timestamp_ns;
  // Stabilization homography is computed frame-by-frame,
  // and it supports user zooming in/out that corresponds to different image crops.
  float zoom_ratio;
  // Full camera sensor size is a static property. A central crop of camera sensor
  // by ‘sensor_crop’ provides the range of raw image data, to be warped by the EIS
  // homography.
  //
  // EIS homography is applicable to any canvas with the same aspect ratio as the sensor_crop.
  // For any XR system that opens the camera stream of a mobile device, this sensor_crop can
  // be set as the camera stream size.
  std::array<float, 2> sensor_crop;
  // On the warped image data, a further central cropping is made by ‘stable_view’
  // to obtain the image content to be displayed as a stabilized result.
  std::array<float, 2> stable_view;
  int64_t rolling_shutter_readout_ns;
};
class EisManagerInterface {
  public:
  // Handles the thread of the Gyro sensor.
  absl::Status ProcessGyroMeasurements(
    int timestamp_ns, float gyro_x, float gyro_y, float gyro_z);
  // Handles the thread of the OIS sensor.
  absl::Status ProcessOisMeasurements(
    int timestamp ns, float ois dx, float ois dy);
  // Handles the thread of frames, and usually a camera-based image is considered as a frame.
  absl::Status ProcessEisFrameMetaData(
    const EisFrameMetaData& frame_metadata);
  // Outputs two stabilization homography matrices, as described in detail below.
  absl::Status GetEISHomography(
    Eigen::Matrix3f* eis_homography_with_rolling_shutter_compensation,
    Eigen::Matrix3f* eis_homography) const;
};
```

In some implementations, the computing device can be a mobile device and/or a companion device of the computing device can be a mobile device. The mobile device can include (or be equipped with) rolling-shutter cameras. However, XR models and elements may not include rolling shutter distortion. In the presence of a rolling shutter, an image cannot be regarded as a complete image, but each row/column (depending on the rolling shutter specification) is generated at different timestamps, corresponding to different poses and OIS shifts.

Therefore, the EIS warping homography 430 block can be configured to generate two stabilization homography matrices. For example, a first stabilization homography matrix can be used with rolling shutter compensation for camera-based background images with rolling-shutter distortion. For example, a first stabilization homography matrix can be used without rolling shutter compensation for virtual content. The computing system can be configured to provide an indication to the EIS warping homography 430 block of the relevant rolling shutter parameters, including its existence, direction, readout duration, and the like.

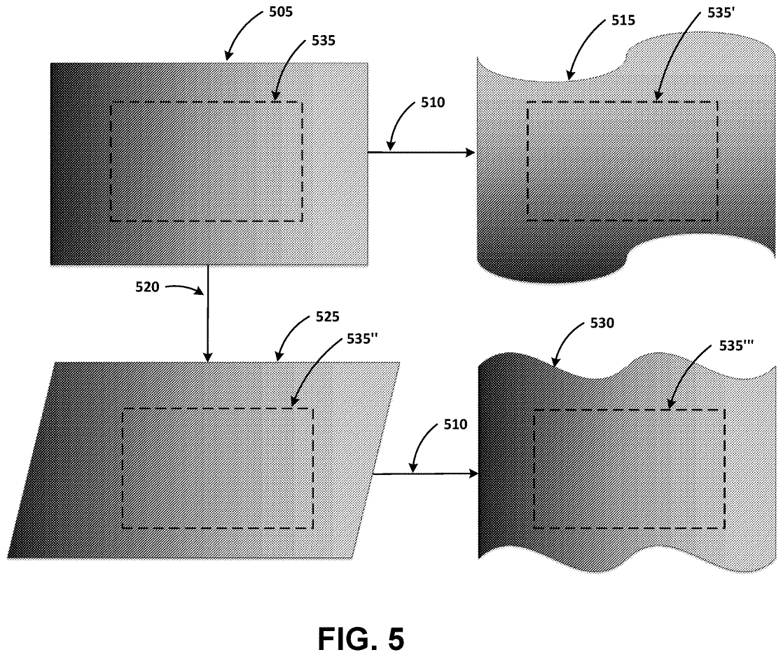

FIG. 5 illustrates outputs of an EIS system using two stabilization homography matrices according to an example implementation. As shown in FIG. 5, image 505 (or a video frame) can include an image portion 535 that can be used as the output of the rendering 435 block. In other words, the camera (e.g., camera 205) can capture an image 505 having first dimensions and the rendering 435 block can output an image having first dimensions (e.g., image portion 535). However, a stabilization warping process 510 can be performed on image 505 to generate image 515. Image 515 can include image portion 535′ representing image portion 535 with stabilization warping. As mentioned above, the computing device can include rolling-shutter cameras. Therefore, the image 505 should be rolling shutter compensated. Accordingly, a rolling shutter compensation process 520 can be performed on image 505 to generate image 525. Image 525 can include image portion 535″ representing image portion 535 with rolling shutter compensation. Further, a stabilization warping process 510 can be performed on image 525 to generate image 530. Image 530 can include image portion 535′″ representing image portion 535 with rolling shutter compensation and stabilization warping.

From the perspective of the human users, an EIS module brings in stabilization effects on the streaming videos. However, from the perspective of the XR motion tracking and rendering modules, the EIS module brings in unexpected distortion and coordinate misalignment, because they rely on the original (e.g., un-stabilized) images and/or videos with compatible pre-calibrations for visual constraints and user interactions. In some implementations, device motion tracking and EIS can be fused in a computing system to render the stabilized videos and digital contents by EIS. In other words, XR rendering steps should be adapted to EIS warped space. For example, device motion tracking and EIS can include a uniform world coordinate. In other words, device motion tracking and EIS define their respective 3D world coordinates and image coordinates in the internal implementations. In some implementations, the respective 3D world coordinates can be transformed into the same coordinate system for consistent rendering.

For example, device motion tracking and EIS can include EIS homography in an application programming interface (API) for rendering 2D and 3D vector graphics context (e.g., OpenGL). In API for rendering 2D and 3D vector graphics-based rendering, XR elements can be positioned through a matrix defined as m=projection*view*model in the application view. If the background image itself is warped by EIS homography for stabilization, the XR elements also go through the EIS warping. In some implementations, EIS warping homography is combined with the camera projection matrix of the virtual content, including virtual stickers, 3D point clouds, structural planes, occlusions and shadows, and/or the like, so that they can be correctly rendered on the EIS warped background. Then the rendering matrix turns to be defined as m=homography*projection*view*model.

For example, device motion tracking and EIS can include user interaction with virtual content under warped space. In XR experience, the background image serves as an intermediate canvas for user interaction. For example, users can click the image to place some virtual stickers/effects at the clicked positions. However, this interaction can rely on the real-time motion tracking of device poses from the coordinate of the original image, instead of the EIS warped image. Therefore, the user clicked position at the stabilized image and/or video should cancel the EIS warping before it is used to determine the rendering position of those virtual stickers/effects. In some implementations, an inverse EIS warping is applied to the user clicked positions.

As mentioned above, at least one technical problem is that AR systems can use a sequence of images from the camera and other sensor data (accelerometer, mainly, called IMU) to generate a 3D perspective and/or assessment of the real-world over time. The AR system can be configured to synchronize the image and IMU data and then process the image and IMU data to determine where the AR device is and how the AR device is moving through the real-world scene. In other words, the AR device rendering algorithm can work when the algorithm can match the motion in the IMU with motion in the images over time. However, the at least one technical problem is that in AR systems EIS manipulates the image such that motion is smoothed over short time frames. The smoothing causes other sensor data to no longer match the image data. If the AR system can't correlate the motion of the image data with the motion reported by the accelerometers, the AR system can't properly determine the real-world scene that the AR system is viewing.

However, the AR system can include APIs configured to interact with the 3D data and share the data with application(s) operating on the AR system. For example, an API can share 3D data for a Hit Test, which is identifying a pixel (e.g., a pixel coordinate) on the display and determining what 3D object in the scene that pixel belongs to. As an example, a laser can be sent through a pixel into the 3D scene. The AR system can be configured to use an application to determine what object laser hit using 3D data shared via the API. At least one technical problem can be that EIS can interfere with the process because the image shown on the display of the device won't correlate to what is behind the camera. In other words, EIS is configured to manipulate the image. Therefore, some implementations can solve this technical problem by undoing the image manipulation on the imaginary ray we're casting into the scene so the Hit Test application works properly.

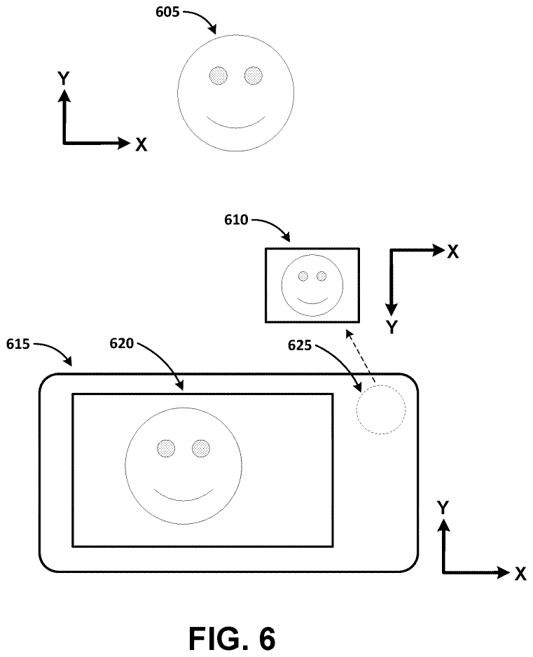

An AR system EIS can be configured to correct shakes in the video. Some AR system EIS implementations can provide AR system client applications with raw compensation transforms when a client application turns on the EIS for the current session. The AR application can be configured to apply the raw compensation transforms when rendering the background (image of the real-world scene) and the virtual objects in the scene. Some implementations move EIS logic APIs and allow AR system client applications to use EIS with just a configuration change. FIG. 6 illustrates camera elements of an EIS system according to an example implementation. In FIG. 6 object 605 represents a real-world scene, block 610 represents a camera sensor view of the real-world scene, device 615 includes a camera 625 sensing the real-world scene, and viewfinder 620 can be configured to display the real-world scene to a user of device 615.

In some implementations, the API associated with EIS can be enabled (e.g., instantiated, turned on, and the like) by the client application using, for example, a session configuration variable. Once the API associated with EIS is enabled, the client application can receive two EIS homography transforms as part of a frame of video on each session update. The first EIS homography transform can be a compensation transform for camera texture. In some implementations, the first EIS homography transform can also compensate for the rolling shutter effect (see discussion above). The second first EIS homography transform can be for the virtual objects rendered on the camera texture.

Referring to FIG. 6, first the EIS transforms can follow the camera orientation which is rotated 90 degrees clockwise (block 610) compared to display coordinates of the real-world scene including object 605. Therefore, in some implementations, the client application can be configured to process a transform orientation.

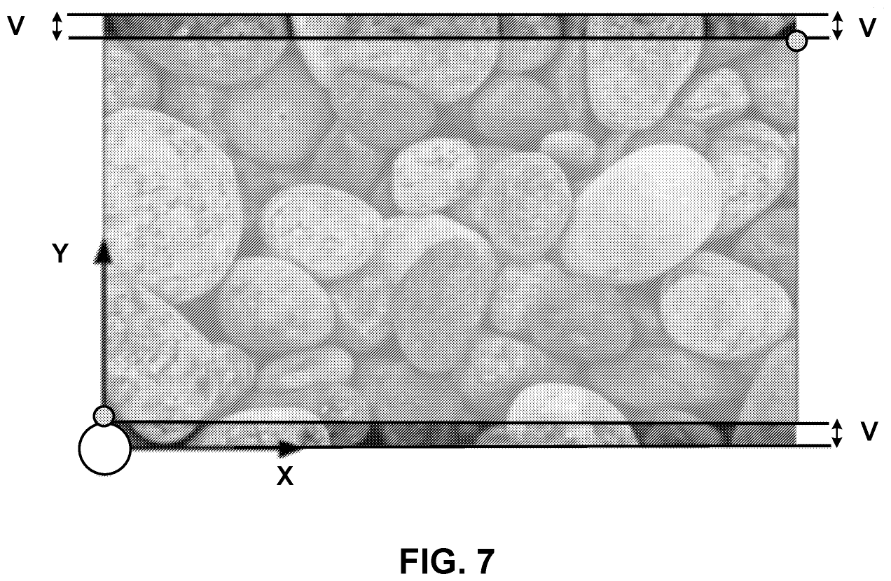

In some implementations, the EIS transforms can be calculated for uncropped camera texture (e.g., see FIG. 7). The client application can be configured to adjust the camera texture crops to match the view aspect ratio (see image portion 535, 535′, 535″, 535′″ of FIG. 5). Therefore, in some implementations, the client application can be configured to modify the EIS' transform based on the cropped view size.

FIG. 7 illustrates camera texture crops to match the view aspect ratio according to an example implementation. For example, the client application can communicate normalized device coordinates (NDC), camera coordinates, and compensation transform to a vertex shader. The vertex shader modifies the screen vertices and camera texture vertices to do perspective correction, V, using 3D coordinates. The output of the operation can be used in the fragment shader.

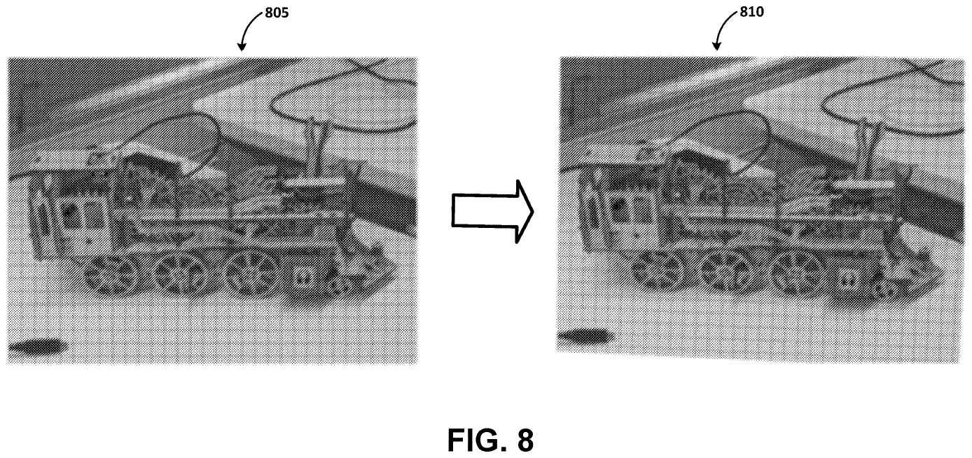

FIG. 8 pictorially illustrates an inverse homography transform according to an example implementation. As discussed above, as an example, when performing a hit test, the client application can apply an inverse of the homography transform to the origin (x, y) of the hit test in order to undo the compensation transform displayed in preview. When rendering the virtual objects in the scene (e.g., point cloud, planes, anchors and the like), the renderer multiplies the homography transform to calculate the final matrix. Image 805 illustrates the original image and image 810 illustrates image 805 after the inverse of the homography transform has been applied.

As mentioned above, the API associated with EIS generates and outputs two homography transforms. In some implementations, there may be a small numeric difference between the two transforms, where the transform to be applied for background image warping takes into account the rolling shutter correction, and the transform to be applied for AR virtual objects are not affected by rolling shutter.

The EIS transforms and client application renderings can be defined in two respective coordinate systems. To integrate the EIS effect into the client application, EIS transforms can go through two coordinate conversion processes, as described below.

The EIS coordinate and client application rendering coordinate can have their 3D axes point to different directions. A point P=[x, y, 1] of background image or virtual AR object can be originally defined in a client application rendering coordinate. Thus, it should be first converted into EIS coordinate, and then applied H for EIS warping, and then converted back into client application rendering coordinate.

$$P\_warped = T * H * T \hat{} \{ - 1 \} * P$$

where,
T can convert a point from EIS to client application rendering coordinate. This conversion is to rotate the EIS coordinate by 90-degrees counterclockwise with respect to the z-axis, and the EIS warping H is Hr for background images and Hg for virtual objects.

$$T = \begin{matrix}[ 0 , 1 , 0 ] , \\ [ - 1 , 0 , 0 ] , \\ [ 0 , 0 , 1 ]\end{matrix}$$

All involved points are defined in normalized space, with x value in [−1, 1] and y value in [−1, 1].

The background image as viewed in the client application can originate from an image stream. Depending on the camera configuration, the input image stream can have a predefined resolution. For example, an image stream from GPU (texture) can have a 16:9 aspect ratio and image stream from CPU can have a 4:3 aspect ratio. This preconfigured aspect ratio of the image stream can be used as EIS metadata. In other words, the two EIS transforms Hr and Hg can be applied to the compatible aspect ratio. Otherwise, a shearing distortion could be observed in the EIS warped background images.

However, the client application's activity view size does not necessarily fit the aspect ratio of the preconfigured image stream. For example, the client application can be displayed in full screen with a short side 1440px and long side 2990px, so its aspect ratio is not 16:9 or 4:3. Therefore, the image stream can be a cropped ratio (see FIG. 7).

There are at least two ways to fix the shearing distortion when the application view size has a different aspect ratio from the configured image stream. In some implementations, the application view size can be set to fit the image stream. For example, if the GPU texture with 16:9 aspect ratio provides the source image data, the app view size can be set as 2560×1440 or a downscaled version but can lock the aspect, instead of using full-screen size 2990×1440.

To not limit the application view size, in some implementations, an extra compensation of the aspect ratio can be used. The extra compensation can define an extra compensation matrix M and applies it to EIS transform matrix by M\hat{ }{−1}*H*M. This compensation should be applied to the rendering of both background image and virtual object.

For the devices with a different screen size or the applications with a different view size, their conversion matrices could be different, but the technique can be to convert the rendering point into a coordinate compatible with EIS aspect ratio. In some implementations of the client application, the coordinate rotation can be performed before the aspect ratio compensation.

In some implementations, camera configurations can be AR system certified. For example, AR system devices can be certified by creating an offline test that probes the camera and sensors on the device to determine if all the camera metadata and sensor data required for EIS is available on that device. Once test results are available, the device profile can be updated to indicate the results offline. At runtime, the session can probe the device profile to see if EIS support is available or not. The benefit of this method is that no runtime checks or logging are required on the device. In some implementations, the presence of metadata can be verified by probing the camera for its characteristics and checking the camera's output metadata stream. Based on the outcome of the checks above, the session will report to the app whether EIS is supported. The same result is logged in analytics. That way the analytics from the wild can be used to update the EIS mode support flag in the device profiles to skip runtime checks on tested devices.

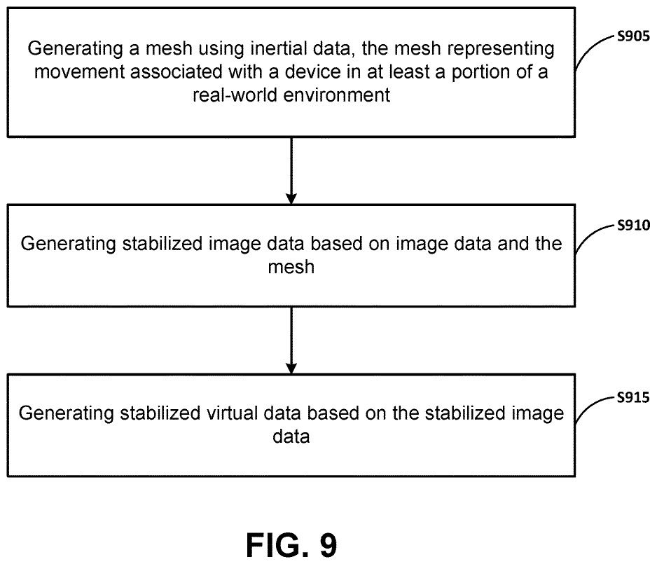

Example 1. FIG. 9 is a block diagram of a method for generating a stabilized image according to an example implementation. As shown in FIG. 9, in step S905 generating a mesh using inertial data, the mesh representing movement associated with a device in at least a portion of a real-world environment. In step S910 generating stabilized image data based on image data and the mesh. In step S915 generating stabilized virtual data based on the stabilized image data.

Example 2. The method of Example 1, wherein the method can further include generating a rendered image for display on the device based on the stabilized image data and the stabilized virtual data.

Example 3. The method of Example 1, wherein the generating of the stabilized image data can include warping the image data based on the mesh.

Example 4. The method of Example 1, wherein the inertial data and the image data can be synchronized.

Example 5. The method of Example 1, wherein the mesh can represent homography data.

Example 6. The method of Example 5, wherein the homography data can be stabilized-image homography data.

Example 7. The method of Example 1, wherein the method can further include prior to generating the stabilized image data, performing roller shutter compensation on the image data.

Example 8. The method of Example 7, wherein the inertial data can include at least one of data captured by an inertial measurement unit (IMU), calibration data, range sensor data, camera rolling shutter information, and camera zooming information.

Example 9. The method of Example 1, wherein the image data can be first image data and the mesh can be a first mesh and the method can further include obtaining second image data, identifying a portion of a user in the second image data, generating a second mesh based on the first mesh, generating un-stabilized image data based on the second image data and the second mesh, and identifying a coordinate associated with the portion of the user based on the un-stabilized image data.

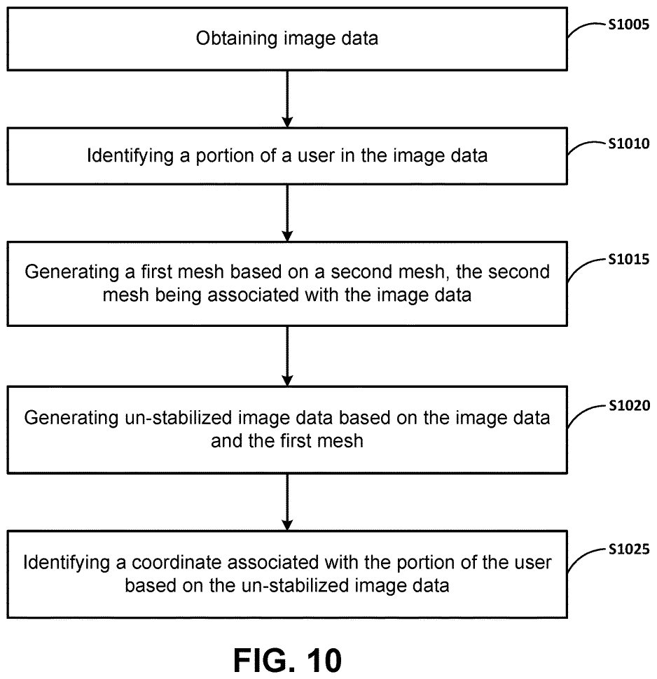

Example 10. FIG. 10 is a block diagram of a method for determining a coordinate in a stabilized image according to an example implementation. As shown in FIG. 10, in step S1005 obtaining image data. In step S1010 identifying a portion of a user in the image data. In step S1015 generating a first mesh based on a second mesh, the second mesh being based associated with the image data. In step S1020 generating un-stabilized image data based on the image data and the first mesh. In step S1025 identifying a coordinate associated with the portion of the user based on the un-stabilized image data.

Example 11. The method of Example 10, wherein the generating of the un-stabilized image data can include warping the image data based on the first mesh.

Example 12. The method of Example 10, wherein the first mesh can represent homography data.

Example 13. The method of Example 12, wherein the homography data can be stabilized-image homography data.

Example 14. A method can include any combination of one or more of Example 1 to Example 13.

Example 15. A non-transitory computer-readable storage medium comprising instructions stored thereon that, when executed by at least one processor, are configured to cause a computing system to perform the method of any of Examples 1-14.

Example 16. An apparatus comprising means for performing the method of any of Examples 1-14.

Example 17. An apparatus comprising at least one processor and at least one memory including computer program code, the at least one memory and the computer program code configured to, with the at least one processor, cause the apparatus at least to perform the method of any of Examples 1-14.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
generating a mesh using inertial data, the mesh representing movement associated with a device in at least a portion of a real-world environment;
generating stabilized image data based on image data and the mesh; and
generating stabilized virtual data based on the stabilized image data.

2. The method of claim 1, further comprising generating a rendered image based on the stabilized image data and the stabilized virtual data for display on the device.

3. The method of claim 1, wherein the generating of the stabilized image data includes warping the image data based on the mesh.

4. The method of claim 1, wherein the inertial data and the image data are synchronized such that the inertial data and the image data are aligned to a time associated with capturing data.

5. The method of claim 1, wherein the mesh represents homography data, the homography data includes an invertible mapping of a plurality of points and a plurality of lines on a plane.

6. The method of claim 5, wherein the homography data is stabilized-image homography data.

7. The method of claim 1, further comprising prior to generating the stabilized image data, performing roller shutter compensation on the image data.

8. The method of claim 1, wherein the inertial data includes at least one of data captured by an inertial measurement unit (IMU), calibration data, range sensor data, camera rolling shutter information, and camera zooming information.

9. The method of claim 1, wherein the image data is first image data and the mesh is a first mesh, the method further comprising:
obtaining second image data;
identifying a portion of a user in the second image data;
generating a second mesh based on the first mesh;
generating un-stabilized image data based on the second image data and the second mesh; and
identifying a coordinate associated with the portion of the user based on the un-stabilized image data.

10. A non-transitory computer-readable storage medium comprising instructions stored thereon that, when executed by at least one processor, are configured to cause a computing system to:
receive a mesh generated using inertial data, the mesh representing movement associated with a device in at least a portion of a real-world environment;
generate stabilized image data based on image data and the mesh; and
generate stabilized virtual data based on the stabilized image data.

11. The non-transitory computer-readable storage medium of claim 10, wherein the instructions are further configured to cause the computing system to generate a rendered image based on the stabilized image data and the stabilized virtual data for display on the device.

12. The non-transitory computer-readable storage medium of claim 10, wherein the generating of the stabilized image data includes warping the image data based on the mesh.

13. The non-transitory computer-readable storage medium of claim 10, wherein the inertial data and the image data are synchronized such that the inertial data and the image data are aligned to a time associated with capturing data.

14. The non-transitory computer-readable storage medium of claim 10, wherein the mesh represents homography data, the homography data includes an invertible mapping of a plurality of points and a plurality of lines on a plane.

15. The non-transitory computer-readable storage medium of claim 14, wherein the homography data is stabilized-image homography data.

16. The non-transitory computer-readable storage medium of claim 10, wherein prior to generating the stabilized image data, the instructions are further configured to cause the computing system to perform roller shutter compensation on the image data.

17. The non-transitory computer-readable storage medium of claim 10, wherein the inertial data includes at least one of data captured by an inertial measurement unit (IMU), calibration data, range sensor data, camera rolling shutter information, and camera zooming information.

18. The non-transitory computer-readable storage medium of claim 10, wherein the image data is first image data and the mesh is a first mesh and the instructions are further configured to cause the computing system to:
obtain second image data;
identify a portion of a user in the second image data;
generate a second mesh based on the first mesh;
generate un-stabilized image data based on the second image data and the second mesh; and
identify a coordinate associated with the portion of the user based on the un-stabilized image data.

19. A system comprising at least one processor and at least one memory including computer program code, the at least one memory and the computer program code configured to, with the at least one processor, cause the system to:
receive a mesh generated using inertial data, the mesh representing movement associated with a device in at least a portion of a real-world environment;
generate stabilized image data based on image data and the mesh; and
generate stabilized virtual data based on the stabilized image data.

20. The system of claim 19, wherein the computer program code is further configured to cause the system to generate a rendered image based on the stabilized image data and the stabilized virtual data for display on the device.

21-34. (canceled)
